(19) United States
(12) Patent Application Publication
(10) Pub. No.: US 2005/0238933 A1
(43) Pub. Date: Oct. 27, 2005

(54) Fuel processing device, fuel cell system having the same, and method of driving thereof

(76) Inventors: Ju-Yong Kim, Suwon-si (KR); Hyoung-Juhn Kim, Suwon-si (KR); Ho-Jin Kweon, Suwon-si (KR)

Correspondence Address: MCGUIREWOODS, LLP, 1750 TYSONS BLVD, SUITE 1800, MCLEAN, VA, 22102, US

(21) Appl. No.: 11/109,678

(22) Filed: Apr. 20, 2005

(30) Foreign Application Priority Data
Apr. 21, 2004 (KR) 10-2004-0027410

(51) Int. Cl. H01M 8/00; C10L 1/04

(52) U.S. Cl. 429/13; 429/34; 208/15

(57) ABSTRACT

The present invention provides a fuel cell system that comprises a stack that generates electricity through a reaction between hydrogen and oxygen and a fuel processing device that is connected to the stack to generate the hydrogen from fuel and supplies the hydrogen to the stack. It further comprises a fuel supply unit that supplies the fuel to the fuel processing device and an air supply unit that supplies air to the stack and the fuel processing unit, respectively. The fuel processing device comprises a first reformer that generates byproducts along with the hydrogen through an electrolysis reaction of the fuel using electric energy and a second reformer that generates the hydrogen through a reformation reaction of the fuel using thermal energy.

### CROSS REFERENCE TO RELATED APPLICATION

This application claims priority to and the benefit of Korean Patent Application No. 10-2004-0027410 filed on Apr. 21, 2004 in the Korean Intellectual Property Office, the content of which is incorporated by reference as if fully set forth herein.

### BACKGROUND OF THE INVENTION

(a) Field of the Invention

The present invention relates to a fuel cell system that has a complex fuel processing device that uses electric and thermal energy.

(b) Description of the Related Art

In general, a fuel cell is an electricity generating system that directly converts chemical energy that is generated from a reaction between hydrogen that is contained in hydrocarbon materials such as methanol, ethanol, and natural gas, and oxygen into electric energy.

The recently developed polymer electrolyte membrane fuel cell (PEMFC) has excellent output, a low operating temperature, and fast starting and response characteristics when compared with other fuel cells. The PEMFC has a wide range of applications including use as a mobile power source for vehicles, a distributed power source for homes or buildings, and a small-sized power source for electronic devices.

The PEMFC basically requires a stack, a reformer, a fuel tank, and a fuel pump. The stack constitutes a main body of a fuel cell that generates electricity through a reaction between hydrogen and oxygen. The fuel pump supplies fuel that is stored in the fuel tank to the reformer. Then, the reformer converts the fuel to generate hydrogen and supplies the hydrogen to the stack.

The reformer of the PEMFC generates hydrogen from the fuel through a catalytic chemical reaction that requires the input of thermal energy. Therefore, the reformer includes a heat source unit that generates thermal energy and a reformation unit that generates hydrogen through the conversion of the fuel using the thermal energy. The heat source unit generates thermal energy that is generated through an oxidation reaction between the fuel and oxygen using an oxidizing catalyst.

Since the reformer generates thermal energy through the oxidation reaction between the fuel and oxygen, and generates hydrogen through the reformation reaction of the fuel using the thermal energy, the starting-up time required for these reactions is elongated. This causes the system load to be concentrated on the reformer, which decreases the overall performance of the fuel cell system.

Various studies for rapidly starting up the system and distributing the system load have been advanced. An example of such a reformer is disclosed in U.S. Pat. No. 6,299,744 which converts the fuel into hydrogen and byproducts such as carbon monoxide and carbon dioxide. This reformer helps to start up a system and distribute the system load, but it is detrimental to the performance and reliability of a system because the byproducts are not removed or reused but are instead directly discharged.

In a conventional fuel cell system, the stack discharges the unreacted hydrogen that remains after generating electricity. At this time, the unreacted hydrogen is not reused and is discharged, thereby diminishing the thermal efficiency of the whole fuel cell system.

### SUMMARY OF THE INVENTION

The present invention provides a fuel processing device, a fuel cell system comprising the fuel processing device, and a method for driving the fuel processing device.

The present invention provides a complex fuel processing device that generates hydrogen from fuel using electrical and thermal energy. Thus, it is possible to shorten the starting-up time of a fuel cell system and to distribute the load that is concentrated on the reformer. This improvement enhances the performance of the whole fuel cell system.

In addition, since the byproducts that are discharged from a first reformer and the unreacted hydrogen that is discharged from the stack can be reused as a heat source for the second reformer, it is possible to reduce fuel consumption and to improve the thermal efficiency of the whole fuel cell system.

Additional features of the invention will be set forth in the description which follows, and in part, will be apparent from the description or may be learned by practice of the invention.

The present invention discloses a fuel processing device for a fuel cell system that is connected to a stack that generates electricity through a reaction between hydrogen and oxygen, generates hydrogen from fuel, and supplies the hydrogen to the stack. The fuel processing device comprises a first reformer that generates hydrogen through an electrolysis reaction of the fuel using electrical energy and a second reformer that generates hydrogen through a reformation reaction of the fuel using thermal energy.

The present invention also discloses a fuel cell system that comprises a stack that generates electricity through a reaction between hydrogen and oxygen and a fuel processing device that is connected to the stack to generate the hydrogen from fuel and which supplies the hydrogen to the stack. The fuel cell system also comprises a fuel supply unit that supplies the fuel to the fuel processing device and an air supply unit that supplies air to the stack and the fuel processing unit, respectively. The fuel processing device comprises a first reformer that generates hydrogen through an electrolysis reaction of the fuel using electrical energy. The fuel processing device further comprises a second reformer that generates the hydrogen through a reformation reaction of the fuel using thermal energy.

The present invention also discloses a method of driving a fuel cell system that comprises a stack that generates electricity through a reaction between hydrogen and oxygen. The fuel cell system includes a first reformer that generates the hydrogen through an electrolysis reaction of fuel using the electrical energy, and a second reformer that generates the hydrogen through a reformation reaction of the fuel using thermal energy. The method comprises driving the first and second reformer when starting up the fuel cell system, allowing the first reformer to generate the hydrogen and to supply the resulting hydrogen to the stack, and allowing the second reformer to generate the hydrogen and to supply the hydrogen to the stack.

It is to be understood that both the foregoing general description and the is following detailed description are exemplary and explanatory and are intended to provide further explanation of the invention as claimed.

### BRIEF DESCRIPTION OF THE DRAWINGS

The above and other features and advantages of the present invention will become more apparent by describing in detail exemplary embodiments thereof with reference to the attached drawings.

FIG. 1 is a block diagram that schematically illustrates an entire construction of a fuel cell system according to a first embodiment of the present invention.

FIG. 2 is an exploded perspective view that illustrates a structure of a stack shown in FIG. 1.

FIG. 3 is a cross-sectional view that schematically illustrates a structure of a first reformer shown in FIG. 1.

FIG. 4 is a cross-sectional view that schematically illustrates a structure of a second reformer shown in FIG. 1.

FIG. 5 is a block diagram that schematically illustrates a construction of a fuel cell system according to a second embodiment of the present invention.

FIG. 6 is a block diagram that schematically illustrates a construction of a fuel cell system according to a third embodiment of the present invention.

FIG. 7 is a block diagram that schematically illustrates a construction of a fuel cell system according to a fourth embodiment of the present invention.

### DETAILED DESCRIPTION OF THE EMBODIMENTS

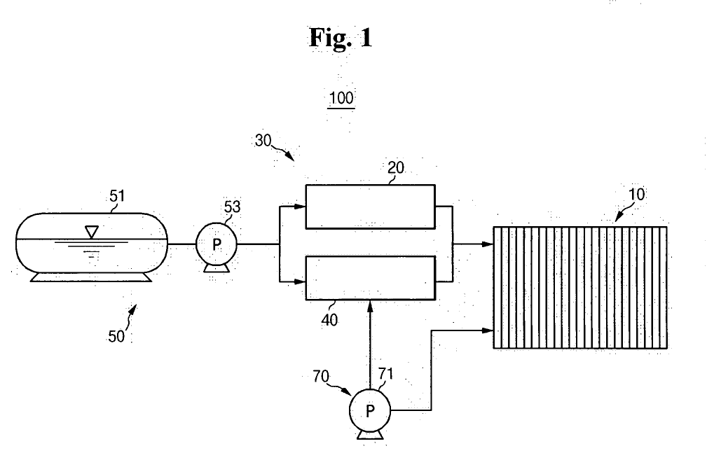

FIG. 1 is a block diagram that schematically illustrates an entire construction of a fuel cell system according to a first embodiment of the present invention.

Referring to FIG. 1, a fuel cell system 100 according to the first embodiment has a PEMFC scheme which reforms fuel to generate hydrogen and allows the hydrogen and oxygen to react with each other to generate electricity.

The fuel used in the fuel cell system 100 may include liquid or gaseous fuel that contains hydrogen such as methanol, ethanol, or natural gas, for example. The fuel described below in the present embodiment is in liquid form.

The fuel cell system 100 may utilize pure oxygen that is stored in an additional storage device to react with hydrogen or it may utilize air that comprises oxygen. The following description uses oxygen from air.

The fuel cell system 100 comprises a stack 10 that generates electricity through a reaction between hydrogen and oxygen and a fuel processing device 30 that reforms fuel to generate hydrogen and supplies the hydrogen to the stack 10. The fuel cell system 100 further comprises a fuel supply unit 50 that supplies the fuel to the fuel processing device 30 and an air supply unit 70 that supplies air to the stack 10.

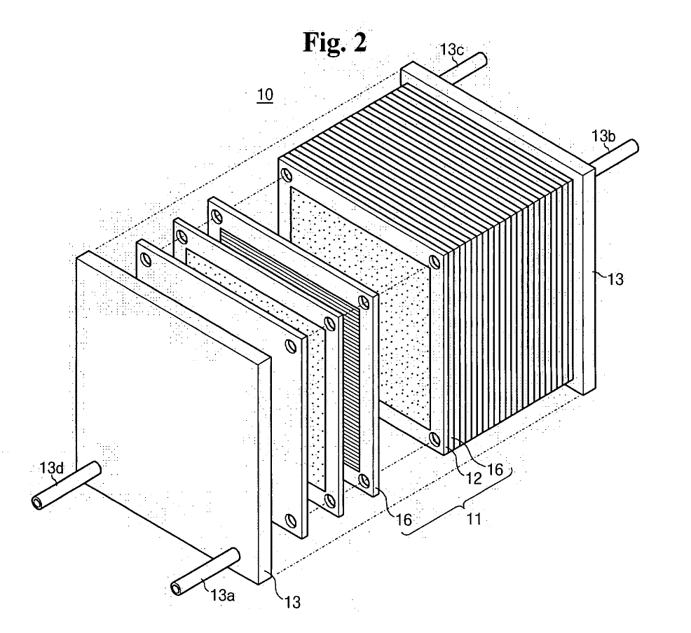

As shown in FIG. 2, the stack 10 comprises an electricity generating unit 11 that generates electricity through an electrochemical reaction between hydrogen and oxygen. The electricity generating unit 11 is a unit fuel cell in which separators, also called “bipolar plates,” 16 are disposed on both surfaces of a membrane-electrode assembly (MEA) 12. By sequentially stacking a plurality of electricity generating units 11, the stack 10 may be formed.

An MEA 12 comprises an anode which is formed on one surface of the MEA, a cathode which is formed on the other surface of the MEA 12, and an electrolyte membrane which is formed in between the anode and the cathode. The anode separates hydrogen into electrons and hydrogen ions. The electrolyte membrane serves as a medium for transporting the hydrogen ions to the cathode. The cathode generates water as a byproduct of the reaction of the electrons and the hydrogen ions supplied from the anode electrode side and oxygen contained in the air.

The separators 16 supply the hydrogen and oxygen to the MEA 12, and also couple the anode and the cathode of the MEA 12.

The outermost edge of the stack 10 may be provided with a pressing plate 13 for compressing the plurality of electricity generating units 11. However, the stack 10 according to the present invention may also be constructed without the pressing plate 13 where the separators 16 are positioned at the outermost sides of the electricity generating units 11 to compress the plurality of electricity generating units 11.

In addition, the pressing plate 13 comprises a hydrogen injection port 13a for supplying hydrogen to the electricity generating units 11, an air injection port for supplying air to the electricity generating units 11, an unreacted hydrogen discharge port 13c for discharging unreacted hydrogen from the electricity generating units 11, and a water discharge port 13d for discharging unreacted air from electricity generating units 11 and water generated through the reaction between hydrogen and oxygen.

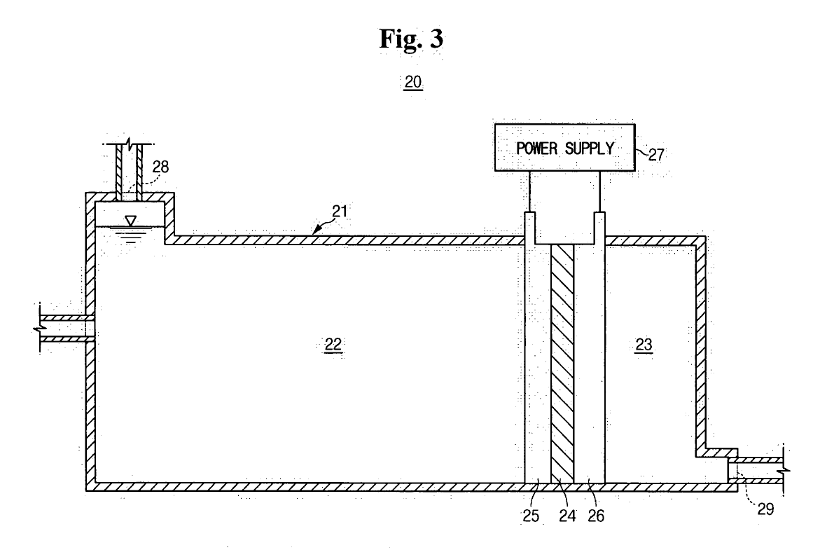

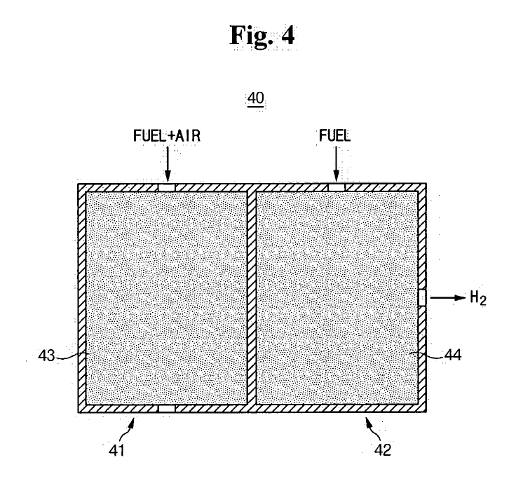

In the present embodiment, the fuel processing device 30 comprises a first reformer 20 that generates hydrogen from the fuel using electricity and a second reformer 40 that generates hydrogen from the fuel using thermal energy. The structures of the first and second reformers 20 and 40 will be described later in detail with reference to FIGS. 3 and 4.

The fuel supply unit 50 supplies fuel to the first and second reformers 20 and 40 of the fuel processing device 30, and comprises a fuel tank 51 that stores fuel and a fuel pump 53 that has a conventional structure for discharging the fuel from the fuel tank 51.

The air supply unit 70 comprises at least one air pump 71 that may take in air from the atmosphere or from another source and supplies the air to the electricity generating units 11 of the stack 10 and the second reformer 40 of the fuel processing device 30. In the present embodiment as shown in FIG. 1, the air supply unit 70 supplies air to the electricity generating units 11 and the second reformer 40 through the single air pump 71. However, the air supply unit 70 is not limited to this configuration and may instead comprise a pair of air pumps that are connected to the electricity generating units 11 and the second reformer 40. In addition, the air supply unit 70 may comprise a fan instead of the air pump 71.

FIG. 3 is a cross-sectional view that schematically illustrates a structure of the first reformer shown in FIG. 1.

Referring to FIG. 3, the first reformer 20 according to this exemplary embodiment generates hydrogen through an electrolysis reaction of fuel using electricity which is disclosed in U.S. Pat. No. 6,299,744.

The first reformer 20 comprises a housing 21 that forms a predetermined inner space. An electrolyte membrane 24 partitions the inner space of the housing 21 into independent spaces to form an anode chamber 22 and a cathode chamber 23. An anode 25 is disposed on one side of the electrolyte membrane 24 in the anode chamber 22 and a cathode 26 is disposed on the other side of the electrolyte membrane 24 in the cathode chamber 23. A power supply 27, which is connected to the anode 25 and the cathode 26, applies a voltage to the anode 25 and the cathode 26.

The anode chamber 22 is connected to the fuel tank 51 through a pipe line and receives the fuel that is supplied from the fuel tank 51. The cathode chamber 23 forms an empty space that is separate from the inner space of the anode chamber 22 with the electrolyte membrane 24. The anode 25 is formed on one surface of the electrolyte membrane 24 as a catalyst for an oxidation reaction. The cathode 26 is formed on the other surface of the electrolyte membrane 24 as a catalyst for a reduction reaction. The anode chamber 22 comprises a byproduct discharge port 28 for discharging byproducts that are generated through the oxidation reaction of the anode 25, such as carbon monoxide and carbon dioxide, for example. The cathode chamber 23 comprises a hydrogen discharge port 29 for discharging hydrogen that is generated through the reduction reaction at the cathode 26. At this time, the hydrogen discharge port 29 can be connected to the hydrogen injection port 13a of the stack 10 shown in FIG. 2 through a pipe line.

FIG. 4 is a cross-sectional view that schematically illustrates a structure of the second reformer 40 shown in FIG. 1.

Referring to FIG. 4, the second reformer 40 of the exemplary embodiment has a conventional reformer structure for generating hydrogen through a catalytic conversion of fuel using thermal energy, such as steam reformation, partial oxidation, and an auto-thermal reaction.

According to the present embodiment, the second reformer 40 comprises a heat source unit 41 that generates thermal energy through an oxidation reaction between fuel and air. The second reformer 40 further comprises a reformation unit 42 that generates hydrogen from the fuel through a reformation reaction using the thermal energy that is generated from the heat source unit 41.

The heat source unit 41 has a structure for easily delivering the thermal energy that is generated through the oxidation reaction between fuel and air to the reformation unit 42. It also includes a catalyst 43 that promotes the oxidation reaction between fuel and air to combust the fuel and the air. The heat source unit 41 is connected to the fuel tank 51 of the fuel supply unit 50 through a pipe line and may be connected to the air pump 71 of the air supply unit 70.

The reformation unit 42 includes a catalyst 44 that promotes the reformation of fuel generate hydrogen. The reformation unit 42 is connected to the fuel tank 51 of the fuel supply unit 50 through a pipe line and may be connected to the hydrogen injection port 13a of the stack shown in FIG. 2.

According to the present embodiment, the heat source unit 41 and the reformation unit 42 that make up the second reformer 40 may be formed in a vessel as shown in FIG. 4. However, the present invention is not limited to this case; the heat source unit 41 and the reformation unit 42 may instead have a plate form that has a channel that allows fuel necessary for the respective reactions to flow and a catalytic layer is formed in the channel are disposed in close contact with each other.

A method of driving the fuel cell system according to the first exemplary embodiment of the present invention will be described in detail.

First, the fuel pump 53 is activated to supply the fuel that is stored in the fuel tank 51 to the anode chamber 22 of the first reformer 20; the first reformer 20 and the second reformer 40 are activated simultaneously. Then a positive voltage is applied to the anode 25 through the power supply 27 of the first reformer 20 and a negative voltage is applied to the cathode electrode 26. This causes electrolysis reactions to occur simultaneously in the anode 25 and the cathode 26. The reaction generates hydrogen ions (protons), and electrons from the fuel through the oxidation reaction of the anode 25 in the anode chamber 22. At this time, the byproducts such as carbon monoxide and carbon dioxide are discharged through the byproduct discharge port 28 of the anode chamber 22.

Next, the hydrogen ions are moved to the cathode 26 through the electrolyte membrane 24 and the electrons are moved to the cathode 26 through a wire. Then, the cathode chamber 23 generates a sufficient amount of hydrogen for operation of the stack 10 by allowing the hydrogen ions and the electrons to be coupled through the reduction reaction of the cathode electrode 26. The resulting hydrogen is discharged through the hydrogen discharge port 29 of the cathode chamber 23.

Fuel is supplied to the heat source unit 41 of the second reformer 40 by the fuel pump 51 and the air is supplied to the heat source unit 41 by the air pump 71. Then, the heat source unit 41 generates heat through the oxidation between the fuel and oxygen contained in the air, and supplies the thermal energy to the reformation unit 42.

At the same time, fuel is supplied to the reformation unit 42 by the fuel pump 51. Then, the reformation unit 42 generates a sufficient amount of hydrogen to operate the stack 10 through the reformer catalytic reaction of the fuel using the heat from the heat source unit 41.

The second reformer 40 generates hydrogen after the first reformer, even though the second reformer 40 is activated at the same time as the first reformer 20. This is because the first reformer 20 generates hydrogen using electrical energy and thus has a short starting-up time. In contrast the second reformer 40 generates heat through the oxidation reaction between fuel and oxygen and then generates hydrogen through the reformation reaction using heat, and thus has a starting-up time that is longer than the first reformer 20.

When the second reformer 40 generates a sufficient amount of hydrogen, the fuel and power supplied to the first reformer 20 are blocked. Then, the first reformer 20 stops its operation.

The hydrogen that is generated from the reformation unit 42 is supplied to the hydrogen injection port 13a of the stack 10 and the air is supplied to the air injection port 13b of the stack 10 by the air pump 71, simultaneously. Then, the hydrogen and the air are supplied to the MEA 12 through the separators 16. Accordingly, the electricity generating units 111 of the stack 10 generate electricity through the chemical reaction between hydrogen and oxygen contained in the air.

When starting up the fuel cell system 100 according to the first embodiment, the first reformer 20 that uses the electrical energy can generate the hydrogen without entirely depending upon the second reformer 40 that uses the thermal energy. Therefore, the fuel cell system can be started up more rapidly. Also, since the first and second reformers 20 and 40 simultaneously generate a sufficient amount of hydrogen for operation of the stack 10, the load that is concentrated on the second reformer 40 can be distributed.

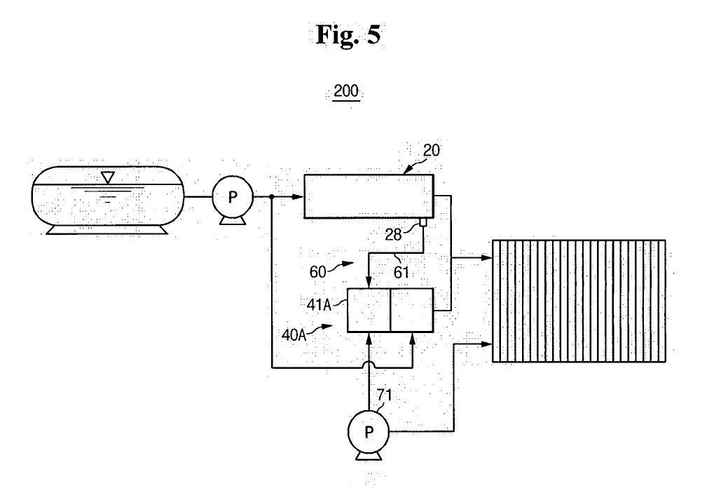

FIG. 5 is a block diagram that schematically illustrates a structure of a fuel cell system according to a second embodiment of the present invention.

Referring to FIG. 5, the fuel cell system 200 according to the second embodiment has the same basic structure as the first embodiment, except that the second reformer 40A can be constructed to generate heat through the oxidation reaction of the byproducts that are discharged through a byproduct discharge port 28 of the first reformer 20.

For this purpose, the fuel cell system 200 according to the present embodiment comprises a first connection unit 60 that connects the byproduct discharge port 28 of the first reformer 20 and a heat source unit 41A of the second reformer 40A to each other. The first connection unit 60 is provided as a first pipeline 61 of which one end is connected to the byproduct discharge port 28 and the other end is connected to the heat source unit 41A.

Therefore, when the byproducts that are discharged through the byproduct discharge port 28 of the first reformer 20 are supplied to the heat source unit 41A of the second reformer 40A through the first pipe line 61 and the air is supplied to the heat source unit 41A by the air pump 71, the heat source unit 41A generates heat through the oxidation reaction between the byproducts and the air.

Since the other construction and operation elements of the fuel cell system 200 according to the second embodiment are the same as those of the first embodiment, their detailed descriptions will be omitted.

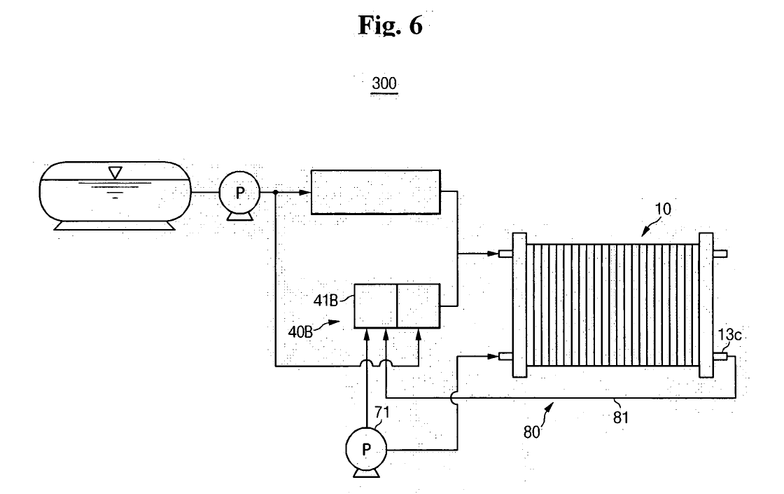

FIG. 6 is a block diagram that schematically illustrates a fuel cell system according to a third embodiment of the present invention.

Referring to FIG. 6, the fuel cell system 300 according to the third embodiment has the same basic structure as the first embodiment, except that the second reformer 40B is generates heat through the oxidation reaction of unreacted hydrogen that is discharged from the unreacted hydrogen discharge port 13c of the stack 10.

For this purpose, the fuel cell system 300 according to the third embodiment comprises a second connection unit 80 for connecting the unreacted hydrogen discharge port 13c of the stack 10 and the heat source unit 41B of the second reformer 40B. The second connection unit 80 is provided as a second pipe line 81 of which one end is connected to the unreacted hydrogen discharge port 13c and the other end is connected to the heat source unit 41B.

When the unreacted hydrogen that is discharged from the unreacted hydrogen discharge port 13c of the stack 10 is supplied to the heat source unit 41B of the second reformer 40B through the second pipe line 81 and the air is supplied to the heat source unit 41B by the air pump 71, the heat source unit 41B generates heat through the oxidation reaction between the unreacted hydrogen and oxygen.

Since the construction and operation of the fuel cell system 300 according to the third embodiment are otherwise the same as those of the first embodiment, their detailed descriptions will be omitted.

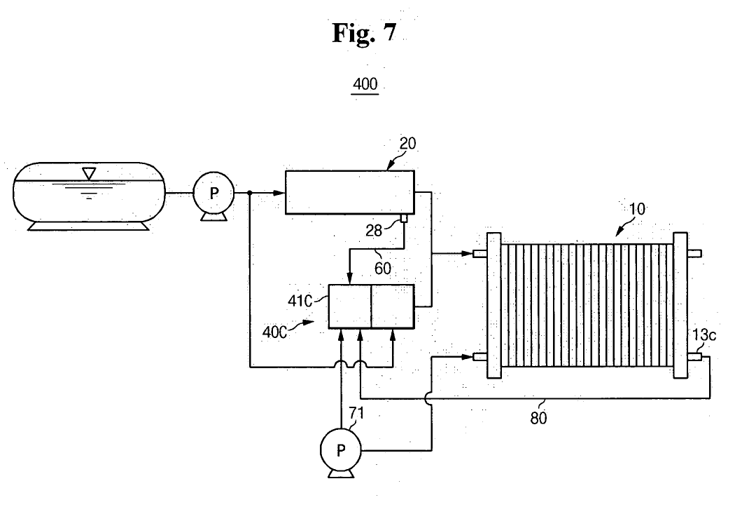

FIG. 7 is a block diagram that schematically illustrates a construction of a fuel cell system according to a fourth embodiment of the present invention.

Referring to FIG. 7, the fuel cell system 400 according to the fourth embodiment has the same basic structure as the embodiments described above, except that the second reformer 40C is constructed to generate heat through the oxidation reaction between byproducts that are discharged from the byproduct discharge port 28 of the first reformer 20 and unreacted hydrogen that is discharged from the unreacted hydrogen discharge port 13c of the stack 10.

For this purpose, the fuel cell system 400 according to the fourth embodiment comprises a first connection unit 60 that connects the byproduct discharge port 28 of the first reformer 20 and the heat source unit 41C of the second reformer 40C. It further comprises a second connection unit 80 that connects the unreacted hydrogen discharge port 13c of the stack 10 and the heat source unit 41C of the second reformer 40C. The first connection unit 60 and the second connection unit 80 of the fourth embodiment have the same structures as the first and second connection units of the second and third embodiments, respectively, and thus their detailed description will be omitted.

The byproducts that are discharged from the byproduct discharge port 28 of the first reformer 20 are supplied to the heat source unit 41C of the second reformer 40C through the first connection unit 60. The unreacted hydrogen that is discharged from the unreacted hydrogen discharge port 13c of the stack 10 is supplied to the heat source unit 41C of the second reformer 40C through the second connection unit 80. Then, the heat source unit 41C generates heat is through the oxidation reaction between the byproducts and unreacted hydrogen and oxygen that is present in the air supplied to the heat source unit 41B by the air pump 71.

The present invention provides a complex fuel processing device that generates hydrogen from fuel using the electric energy and the thermal energy. Thus, it is possible to shorten the starting-up time of a fuel cell system and to distribute the load that is concentrated on the reformer using the heat. Therefore, it is possible to further enhance the performance of the whole fuel cell system.

In addition, since the byproducts that are discharged from the first reformer and the unreacted hydrogen that is discharged from the stack can be reused as a heat source of the second reformer, it is possible to reduce the amount of fuel consumption and to improve the thermal efficiency of the whole fuel cell system.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A fuel processing device for a fuel cell system, comprising:
a first reformer that generates hydrogen through an electrolysis reaction of a hydrogen-containing fuel using electrical energy; and
a second reformer that generates hydrogen through a reformation reaction of a hydrogen-containing fuel using thermal energy,
wherein the fuel processing device is connected to a stack that generates electricity through a reaction between hydrogen and oxygen, and
wherein the fuel processing device provides the stack with hydrogen.

2. The fuel processing device of claim 1,
wherein the first reformer comprises:
a first discharge port that discharges the hydrogen; and
a second discharge port that discharges byproducts that are generated along with the hydrogen.

3. The fuel processing device of claim 1,
wherein the second reformer comprises:
a heat source unit that generates thermal energy; and
a reformation unit that generates hydrogen through a reformation reaction that uses the thermal energy from the heat source unit.

4. The fuel processing device of claim 2,
wherein the second reformer comprises:
a heat source unit that generates thermal energy; and
a reformation unit that generates hydrogen through a reformation reaction using the thermal energy from the heat source unit,
wherein the heat source unit is coupled to the second discharge port and generates the thermal energy through an oxidation reaction of the byproducts that are discharged through the second discharge port.

5. The fuel processing device of claim 3,
wherein the heat source unit is connected to the stack and generates thermal energy through an oxidation reaction of unreacted hydrogen that is discharged from the stack.

6. The fuel processing device of claim 4,
wherein the heat source unit is connected to the stack and generates thermal energy through an oxidation reaction of unreacted hydrogen that is discharged from the stack.

7. The fuel processing device of claim 3,
wherein the heat source unit is coupled to a fuel tank that stores the fuel and generates thermal energy through an oxidation reaction of the fuel that is supplied from the fuel tank.

8. A fuel cell system, comprising:
a stack that generates electrical energy through a reaction between hydrogen and oxygen;
a fuel processing device that is connected to the stack to generate hydrogen from fuel and supplies the hydrogen to the stack;
a fuel supply unit that supplies the fuel to the fuel processing device; and
an air supply unit that supplies air to the stack and the fuel processing unit,
wherein the fuel processing device comprises a first reformer that generates byproducts along with hydrogen through an electrolysis reaction of the fuel using the electrical energy and a second reformer that generates hydrogen through a reformation reaction of the fuel using thermal energy.

9. The fuel cell system of claim 8,
wherein the first reformer includes a first discharge port for discharging the hydrogen and a second discharge port for discharging the byproducts.

10. The fuel cell system of claim 8,
wherein the second reformer includes a heat source unit that generates the thermal energy and a reformation unit that generates the hydrogen through a reformation reaction using the thermal energy from the heat source unit.

11. The fuel cell system of claim 9,
wherein the second reformer comprises:
a heat source unit that generates thermal energy and
a reformation unit that generates hydrogen through a reformation reaction using the thermal energy from the heat source unit, and
wherein the second discharge port and the heat source unit are coupled to each other through a first connection unit.

12. The fuel cell system of claim 11,
wherein the heat source unit generates the thermal energy through an oxidation reaction of the byproducts that are supplied through the first connection unit.

13. The fuel cell system of claim 10,
wherein the stack includes at least one electricity generating unit that generates the electrical energy and an unreacted hydrogen discharge port that discharges unreacted hydrogen, and
wherein the unreacted hydrogen discharge port and the heat source unit are coupled to each other through a second connection unit.

14. The fuel cell system of claim 13,
wherein the heat source unit generates the thermal energy through an oxidation reaction of the unreacted hydrogen that is supplied through the second connection unit.

15. The fuel cell system of claim 11,
wherein the stack includes at least one electricity generating unit that generates the electric energy and an unreacted hydrogen discharge port that discharges unreacted hydrogen, and
wherein the unreacted hydrogen discharge port and the heat source unit are coupled to each other through a second connection unit.

16. The fuel cell system of claim 15,
wherein the heat source unit generates the thermal energy through an oxidation reaction of the unreacted hydrogen that is supplied through the second connection unit.

17. The fuel cell system of claim 10,
wherein the heat source unit generates the thermal energy through an oxidation reaction of the fuel that is supplied from the fuel supply unit.

18. A method for driving a fuel cell system, that comprises a stack that generates electrical energy through a reaction between hydrogen and oxygen, the method comprising:
supplying fuel to a first reformer a and second reformer to start up the fuel cell system;
allowing the first reformer to generate the hydrogen and to supply the generated hydrogen to the stack; and
allowing the second reformer to generate the hydrogen and to supply the generated hydrogen to the stack.

19. The method of claim 18, wherein in the driving of the first reformer is stopped after allowing the second reformer to generate and supply a sufficient amount of hydrogen.
